(19) United States
(12) Patent Application Publication
(10) Pub. No.: US 2013/0071768 A1
(43) Pub. Date: Mar. 21, 2013

(54) MEMBRANE ELECTRODE ASSEMBLY AND FUEL CELL STACK

(71) Applicants: Kah-Young Song, Yongin-si (KR); Sung-Yong Cho, Yongin-si (KR); Hee-Tak Kim, Yongin-si (KR); Tae-Yoon Kim, Yongin-si (KR); Myoung-Ki Min, Yongin-si (KR); Jun-Young Kim, Yongin-si (KR)

(72) Inventors: Kah-Young Song, Yongin-si (KR); Sung-Yong Cho, Yongin-si (KR); Hee-Tak Kim, Yongin-si (KR); Tae-Yoon Kim, Yongin-si (KR); Myoung-Ki Min, Yongin-si (KR); Jun-Young Kim, Yongin-si (KR)

(21) Appl. No.: 13/456,009

(22) Filed: Apr. 25, 2012

(30) Foreign Application Priority Data
Sep. 16, 2011 (KR) 10-2011-0093664

(51) Int. Cl. H01M 8/24; H01M 8/10

(52) U.S. Cl. 429/465; 429/480

(57) ABSTRACT

A membrane electrode assembly including an electrolyte membrane; a catalyst layer on the electrolyte membrane; a gas diffusion layer attached to the catalyst layer; and an adhesive layer between the electrolyte membrane and the gas diffusion layer around an outer edge of the catalyst layer, and a fuel cell stack including a plurality of unit cells, each including one of the membrane electrode assemblies.

### CROSS-REFERENCE TO RELATED APPLICATION

This application claims priority to and the benefit of Korean Patent Application No. 10-2011-0093664, filed on Sep. 16, 2011 in the Korean Intellectual Property Office, the entire content of which is incorporated herein by reference.

### BACKGROUND

1. Field

Aspects of embodiments of the present invention relate to a membrane electrode assembly and a fuel cell stack.

2. Description of the Related Art

As known in the related art, a fuel cell is configured to convert chemical reaction energy of hydrogen contained in hydrogen oxide-based fuel and oxygen contained in an oxidizing agent into electrical energy.

Such a fuel cell may be generally categorized as a polymer electrolyte membrane fuel cell or a direct oxidation fuel cell.

The polymer electrolyte membrane fuel cell is configured as a fuel cell body, or stack, and has a structure that generates electrical energy through an electrochemical reaction between hydrogen supplied from a reformer and an oxidizing agent supplied by the activation of an air pump or a fan.

Unlike the polymer electrolyte fuel cell, the direct oxidation fuel cell has a structure that does not use hydrogen and is directly fed with fuel to generate electrical energy through an electrochemical reaction between hydrogen contained in the fuel and an oxidizing agent being separately supplied.

In such a fuel cell, a stack is configured as several to tens of unit cells each consisting of a membrane electrode assembly (MEA) and a separator.

The membrane electrode assembly includes a polymer electrolyte membrane, a pair of catalyst layers installed on both faces of the polymer electrolyte membrane, and a gas diffusion layer (GDS) installed on each of the catalyst layers.

However, it is difficult to avoid the gas diffusion layer affecting the catalyst layer when being installed on the catalyst layer. That is, it is not desirable to directly attach the gas diffusion layer to the catalyst layer.

Therefore, a stack is typically assembled by disposing a pair of gas diffusion layers on both sides of a membrane electrode assembly in a separated state and firmly attaching a separator to the outside of the gas diffusion layers. This causes a process of assembling stacks to be difficult.

The above information disclosed in this Background section is only for enhancement of understanding of the background of the described technology and therefore it may contain information that does not form the prior art that is already known in this country to a person of ordinary skill in the art.

### SUMMARY

According to an aspect of embodiments of the present invention, a membrane electrode assembly and a fuel cell stack have improved adhesion between an electrolyte membrane and a gas diffusion layer, thereby facilitating a stack assembly process.

According to an exemplary embodiment of the present invention, a membrane electrode assembly includes: an electrolyte membrane; a catalyst layer on the electrolyte membrane; a gas diffusion layer attached to the catalyst layer; and an adhesive layer between the electrolyte membrane and the gas diffusion layer around an outer edge of the catalyst layer.

The adhesive layer may be on at least one of the electrolyte membrane or the gas diffusion layer facing each other, and bond the electrolyte membrane and the gas diffusion layer to each other.

An inner edge of the adhesive layer may be spaced apart from the outer edge of the catalyst layer.

The adhesive layer may be arranged as a closed curved line around the outer edge of the catalyst layer.

The membrane electrode assembly may further include an edge protection layer on an outer portion of the electrolyte membrane along the outer edge of the catalyst layer.

The adhesive layer may be on at least one of the edge protection layer or the gas diffusion layer facing each other, and bond the edge protection layer and the gas diffusion layer to each other.

An inner edge of the adhesive layer may be spaced apart from a boundary line between the edge protection layer and the catalyst layer.

The adhesive layer may be arranged as a closed curved line along the edge protection layer.

The adhesive layer may be heat-treated in a vacuum or atmosphere.

The adhesive layer may be heat-treated with ultraviolet rays, electron beams, or visible rays.

The adhesive layer may include at least one of epoxy, urethane, silicon, or acryl.

According to another embodiment of the present invention, a fuel cell stack includes: a plurality of unit cells, each including a membrane electrode assembly and separators attached to both sides of the membrane electrode assembly, respectively; and a pressure plate supporting and applying pressure to the plurality of unit cells, and the membrane electrode assembly includes an electrolyte membrane; a catalyst layer on the electrolyte membrane; a gas diffusion layer attached to the catalyst layer; and an adhesive layer between the electrolyte membrane and the gas diffusion layer around an outer edge of the catalyst layer.

The adhesive layer may be on at least one of the electrolyte membrane or the gas diffusion layer and bond the electrolyte membrane and the gas diffusion layer to each other.

The fuel cell stack may further include an edge protection layer on an outer portion of the electrolyte membrane along the outer edge of the catalyst layer.

The adhesive layer may be on at least one of the edge protection layer or the gas diffusion layer facing each other, and bond the edge protection layer and the gas diffusion layer to each other.

According to an aspect of embodiments of the present invention, an adhesive layer is disposed at the outer edge of a catalyst layer to be interposed between an electrolyte membrane and a gas diffusion layer, and bonds the gas diffusion layer to the electrolyte membrane, thus facilitating a stack assembly process.

### BRIEF DESCRIPTION OF THE DRAWINGS

The accompanying drawings, together with the specification, illustrate some exemplary embodiments of the present invention, and, together with the description, serve to explain aspects and principles of the present invention.

FIG. 1 is a partially exploded perspective view of a fuel cell stack according to an exemplary embodiment of the present invention.

FIG. 2 is an exploded perspective view of a unit cell of the fuel cell stack of FIG. 1.

FIG. 3 is a cross-sectional view of a membrane electrode assembly of the unit cell of FIG. 2.

FIG. 4 is a cross-sectional view of the unit cell of FIG. 2.

FIG. 5 is a top view showing a catalyst layer and an adhesive layer on an electrolyte membrane of the membrane electrode assembly of FIG. 3.

FIG. 6 is a cross-sectional view of a membrane electrode assembly of a unit cell of a fuel cell stack according to another exemplary embodiment of the present invention.

FIG. 7 is a cross-sectional view of a unit cell of a fuel cell stack including the membrane electrode assembly of FIG. 6.

FIG. 8 is a plan view showing an edge protection layer, a catalyst layer, and an adhesive layer on an electrolyte membrane of the membrane electrode assembly of FIG. 6.

Description of Reference Numerals Indicating
Some Elements in the Drawings

| | |
|---|---|
| 10, 60: Unit cell | 13, 15: Separator |
| 13a: Fuel passage | 15a: Oxidizing-agent passage |
| 20, 70: Membrane electrode | 21: Electrolyte membrane |
| assembly (MEA) | |
| 31, 32: Pressure plate | 40: Anode |
| 41: Anode gas diffusion layer | 42: Anode catalyst layer |
| 43, 83: Anode adhesive layer | 44: Anode edge protection layer |
| 50: Cathode | 51: Cathode gas diffusion layer |
| 52: Cathode catalyst layer | 53, 93: Cathode adhesive layer |
| 54: Cathode edge protection layer | 100: Fuel cell stack |
| 201: Active area | 202: Inactive area |
| G1, G21: First Interval | G2, G22: Second interval |

### DETAILED DESCRIPTION

The present invention is described more fully hereinafter with reference to the accompanying drawings, in which some exemplary embodiments of the present invention are shown. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

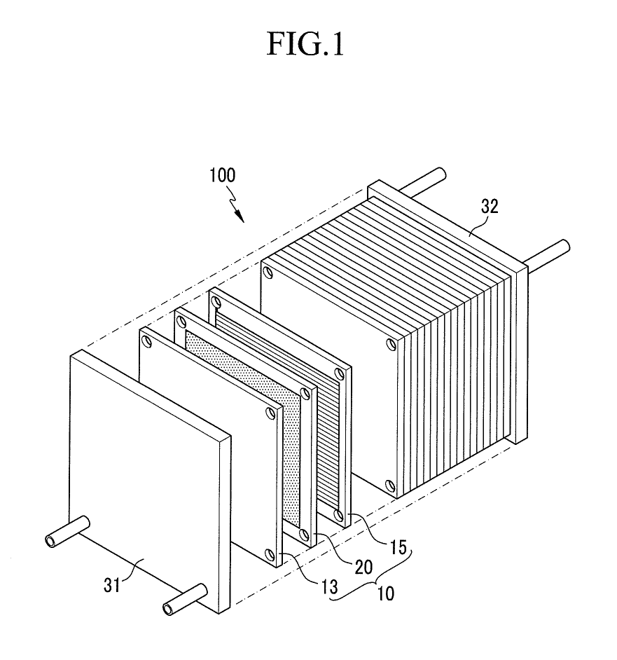

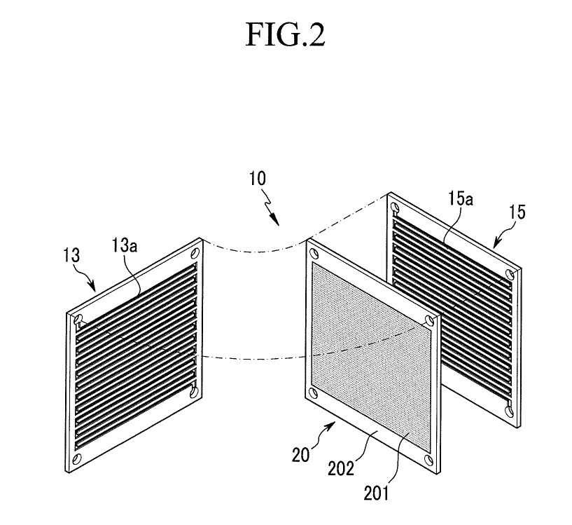

FIG. 1 is a partially exploded perspective view of a fuel cell stack 100 according to an exemplary embodiment of the present invention, and FIG. 2 is an exploded perspective view of a unit cell 10 of the fuel cell stack 100.

Referring to FIG. 1 and FIG. 2, the fuel cell stack 100 according to an exemplary embodiment of the present invention includes a plurality of unit cells 10 generating electrical energy through an electrochemical reaction between an oxidizing agent and fuel. That is, the fuel cell stack 100 is formed as an assembly by successively disposing a plurality of unit cells 10.

The fuel used in the fuel cell stack 100 includes gaseous or liquid fuel containing hydrogen, such as methanol, ethanol, liquefied petroleum gas (LPG), liquefied natural gas (LNG), gasoline, butane gas, or the like.

In one embodiment, the fuel cell stack 100 may utilize pure hydrogen or hydrogen reformed from gaseous or liquid fuel through a typical reformer.

In one embodiment, the fuel cell stack 100 may be configured as a polymer electrode membrane fuel cell generating electrical energy through a reaction between an oxidizing agent and the fuel by the unit cells 10.

The fuel cell stack 100 according to an embodiment of the present invention may be configured as a direct oxidation fuel cell generating electrical energy through a direct reaction between an oxidizing agent and the gaseous or liquid fuel by the unit cells 10.

The fuel cell stack 100 according to an embodiment of the present invention may utilize pure oxygen stored in a separate storage unit as the oxidizing agent reacting with the fuel, or may utilize air containing oxygen.

In the fuel cell stack 100 according to an embodiment of the present invention, each of the unit cells 10 has a membrane electrode assembly (MEA) 20 at a center region, and separators 13 and 15 respectively disposed on both faces of the membrane electrode assembly 20 to be attached (e.g., pressed) together.

The fuel cell stack 100 may include pressure plates 31 and 32 respectively disposed at the outermost sides in a direction in which the unit cells 10 are stacked, such that the plurality of unit cells 10 are firmly attached, or pressed, to each other. However, the present invention is not limited thereto.

For example, in another embodiment, the fuel cell stack may exclude the pressure plates and may instead include separators located at the outermost sides of the plurality of unit cells, so as to function as the pressure plates (this is not illustrated in the accompanying drawings).

The separators 13 and 15 are firmly attached to both sides of the membrane electrode assembly 20 with the membrane electrode assembly 20 interposed therebetween, and have fuel passages 13a and oxidizing-agent passages 15a at both sides of the membrane electrode assembly 20, respectively.

The fuel passages 13a of the separator 13 on one side are positioned at the side of an anode of the membrane electrode assembly 20, which will be described later, and the oxidizing-agent passages 15a on the other side are positioned at the side of a cathode of the membrane electrode assembly 20.

In one embodiment, the fuel passages 13a and the oxidizing-agent passages 15a are linearly disposed in the respective separators 13 and 15 at intervals (e.g., at predetermined intervals). In one embodiment, the fuel passages 13a are alternately connected at both ends in a generally zigzag configuration, and the oxidizing-agent passages 15a are also alternately connected at both ends in a generally zigzag configuration. Of course, the structures of the fuel passages 13a and the oxidizing-agent passages 15a are not limited thereto and, in other embodiments, may have any other suitable structures.

The membrane electrode assembly 20 includes an active area 201 in which an electrochemical reaction takes place, and an inactive area 202 which is adjacent to an edge of the active area 201. The inactive area 202 may be provided with a gasket (not shown) sealing the edges of the closely located faces of the separators 13 and 15 corresponding to the active area 201.

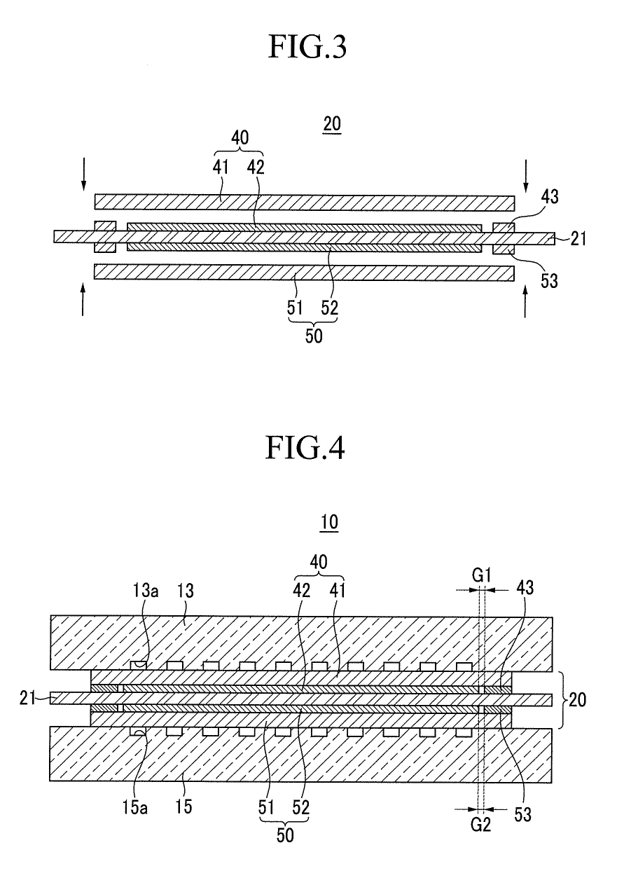

FIG. 3 is a cross-sectional view of the membrane electrode assembly 20 of the unit cell 10, and FIG. 4 is a cross-sectional view of the unit cell 10 of the fuel cell stack 100.

Referring to FIGS. 3 and 4, the membrane electrode assembly 20 has an electrolyte membrane 21 at a center region, and an anode 40 and a cathode 50 disposed on both faces of the electrolyte membrane 21, respectively.

In one embodiment, the electrolyte membrane 21 is formed of a solid polymer electrolyte with a thickness of between 5 μm and 200 μm, thus enabling ion exchange that moves protons generated in an anode catalyst layer 42 to a cathode catalyst layer 52.

The anode 40 forming one face of the membrane electrode assembly 20 is a portion that is fed with a fuel gas through the fuel passages 13a disposed between the separator 13 and the membrane electrode assembly 20. The anode 40 includes the anode catalyst layer 42 and an anode gas diffusion layer 41.

The anode gas diffusion layer 41 includes an anode microporous layer (MPS) (not shown) formed on the anode catalyst layer 42, and an anode backing layer (not shown) formed on the anode microporous layer. The fuel gas is dispersed as passing through the microporous layer and delivered into the anode catalyst layer 42.

The cathode 50 forming the other face of the membrane electrode assembly 20 is a portion that is fed with an oxidizing-agent gas through the oxidizing-agent passages 15a disposed between the separator 15 and the membrane electrode assembly 20. The cathode 50 includes the cathode catalyst layer 52 and a cathode gas diffusion layer 51.

The cathode gas diffusion layer 51 includes a cathode microporous layer (not shown) formed on the cathode catalyst layer 52, and a cathode backing layer (not shown) formed on the cathode microporous layer. The oxidizing-agent gas is dispersed as passing through the cathode microporous layer and delivered into the cathode catalyst layer 52.

In one embodiment, the membrane electrode assembly 20 includes an anode adhesive layer 43 disposed at an outer edge of the anode catalyst layer 42, and a cathode adhesive layer 53 disposed at an outer edge of the cathode catalyst layer 52.

The anode adhesive layer 43 is disposed on a surface of the electrolyte membrane 21 at the outer edge of the anode catalyst layer 42. The anode adhesive layer 43 bonds together the electrolyte membrane 21 and the anode gas diffusion layer 41 at the outer edge of the anode catalyst layer 42.

The cathode adhesive layer 53 is disposed on another surface of the electrolyte membrane 21 at the outer edge of the cathode catalyst layer 52.

The cathode adhesive layer 53 bonds together the electrolyte membrane 21 and the cathode gas diffusion layer 51 at the outer edge of the cathode catalyst layer 52.

In one embodiment, the anode adhesive layer 43 is provided on the electrolyte membrane 21 so as to bond together the electrolyte membrane 21 and the anode gas diffusion layer 41 facing each other. In other embodiments (not shown), the anode adhesive layer 43 may be provided on the anode gas diffusion layer 41, or on both faces of the electrolyte membrane 21 and the anode gas diffusion layer 41 facing each other.

Since the anode adhesive layer 43 is disposed at the outer edge of the anode catalyst layer 42, the anode adhesive layer 43 can bond the anode gas diffusion layer 41 and the electrolyte membrane 21 to each other without interrupting the activation of the anode catalyst layer 42.

In one embodiment, the outer edge of the anode catalyst layer 42 and an inner edge of the anode adhesive layer 43 are spaced apart from each other by a first interval G1. The first interval G1 contributes to preventing or substantially preventing the activation of the anode catalyst layer 42 adjacent to the anode adhesive layer 43 from being interrupted by the anode adhesive layer 43.

In one embodiment, the cathode adhesive layer 53 is provided on the electrolyte membrane 21 so as to bond together the electrolyte membrane 21 and the cathode gas diffusion layer 51 facing each other. In other embodiments (not shown), the cathode adhesive layer 53 may be provided on the cathode gas diffusion layer 51, or on both faces of the electrolyte membrane 21 and the cathode gas diffusion layer 51 facing each other.

Since the cathode adhesive layer 53 is provided at the outer edge of the cathode catalyst layer 52, the cathode adhesive layer 53 can bond the electrolyte membrane 21 and the cathode gas diffusion layer 51 to each other without interrupting the activation of the cathode catalyst layer 52.

In one embodiment, an inner edge of the cathode adhesive layer 53 and the outer edge of the cathode catalyst layer 52 are spaced apart from each other by a second interval G2. The second interval G2 contributes to preventing or substantially preventing the activation of the cathode catalyst layer 52 adjacent to the cathode adhesive layer 53 from being interrupted by the cathode adhesive layer 53.

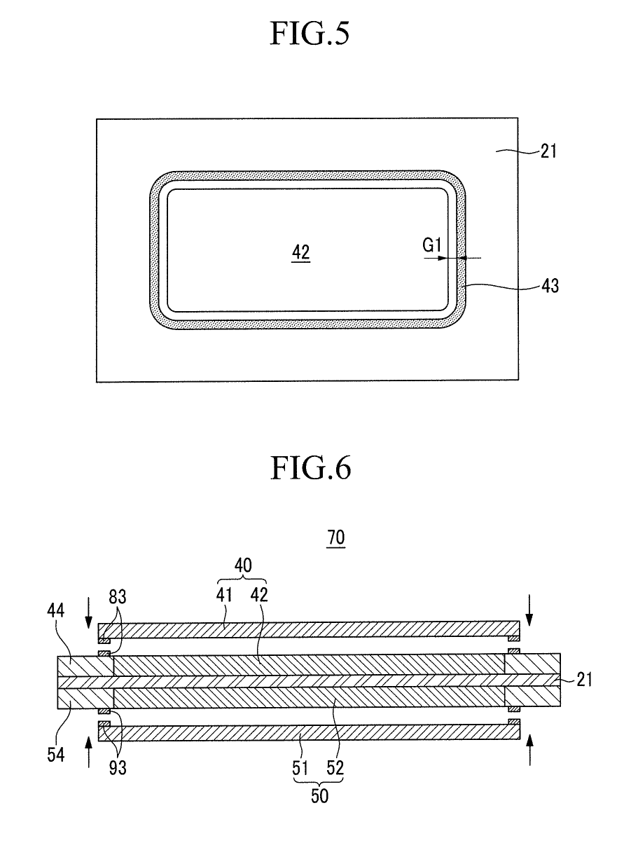

Referring to FIG. 5, in one embodiment, the anode adhesive layer 43 is formed as a closed curved line along the outer edge of the anode catalyst layer 42. Accordingly, the anode adhesive layer 43 provides a stable structure for bonding the anode gas diffusion layer 41 and the electrolyte membrane 21 together.

In one embodiment, the cathode adhesive layer 53 is formed as a closed curved line (not shown) along the outer edge of the cathode catalyst layer 52. Accordingly, the cathode adhesive layer 53 provides a stable structure for bonding the cathode gas diffusion layer 51 and the electrolyte membrane 21 together.

The anode adhesive layer 43 and the cathode adhesive layer 53 are bonded to the electrolyte membrane 21 by pressing the anode gas diffusion layer 41 and the cathode gas diffusion layer 51, respectively, as indicated by the arrows shown in FIG. 3. In one embodiment, the anode adhesive layer 43 and the cathode adhesive layer 53 may then be subjected to a heat treatment in a vacuum or atmosphere. In one embodiment, the anode adhesive layer 43 and the cathode adhesive layer 53 may be heat-treated with ultraviolet rays, electron beams, or visible rays.

In one embodiment, the anode adhesive layer 43 and the cathode adhesive layer 53 may be formed using at least one of epoxy, urethane, silicon, or acryl.

As described above, according to an exemplary embodiment of the present invention, the anode adhesive layer 43 and the cathode adhesive layer 53 are directly formed on the electrolyte membrane 21, bonding the anode gas diffusion layer 41 directly to the anode adhesive layer 43, and bonding the cathode gas diffusion layer 51 directly to the cathode adhesive layer 53.

Hereinafter, another exemplary embodiment will be described. In the following description, description of components and configurations which are the same as those described above is omitted, and only the differences will be described.

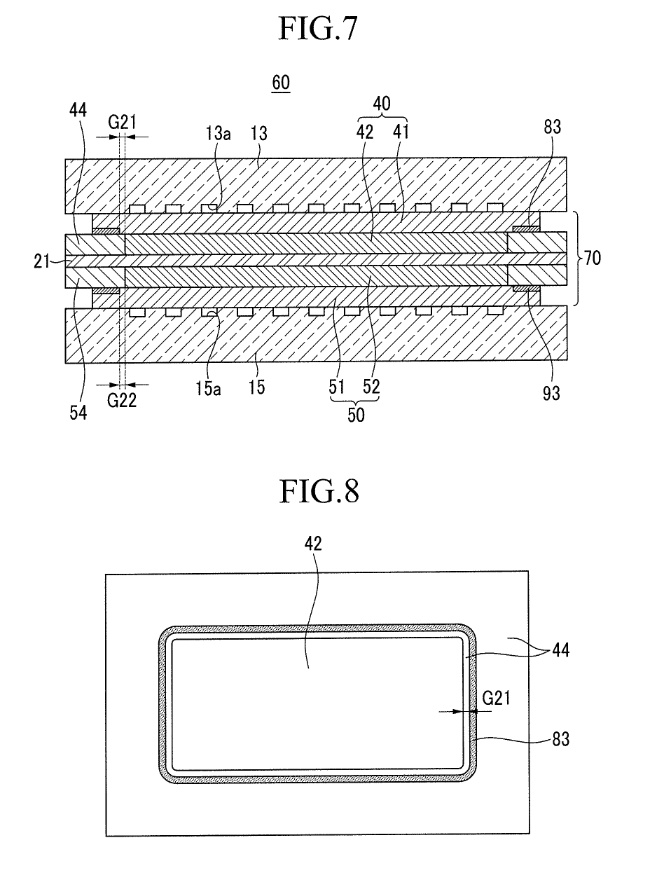

FIG. 6 is a cross-sectional view of a membrane electrode assembly 70 of a unit cell 60 of a fuel cell stack according to another exemplary embodiment of the present invention, and FIG. 7 is a cross-sectional view of the unit cell 60 of a fuel cell stack including the membrane electrode assembly 70.

Referring to FIG. 6 and FIG. 7, unlike the membrane electrode assembly 20 described above, the membrane electrode assembly 70 has an anode edge protection layer 44 and a cathode edge protection layer 54 attached to the edges, or outer portions, of both faces of the electrolyte membrane 21 along the outer edges of the anode catalyst layer 42 and the cathode catalyst layer 52, respectively.

An anode adhesive layer 83 can bond protons together interposed between the anode edge protection layer 44 and the anode gas diffusion layer 41 at the outer edge of the anode catalyst layer 42. A cathode adhesive layer 93 can bond protons together interposed between the cathode edge protection layer 54 and the cathode gas diffusion layer 51 at the outer edge of the cathode catalyst layer 52.

In one embodiment, the anode adhesive layer 83 is provided on the anode edge protection layer 44 and the anode gas diffusion layer 41 facing each other to be bonded to each other, such that the anode gas diffusion layer 41 is attached to the anode edge protection layer 44 and the electrolyte membrane 21.

Since the anode adhesive layer 83 is provided at the outer edge of the anode catalyst layer 42, the anode adhesive layer 83 can bond the anode edge protection layer 44 and the anode gas diffusion layer 41 to each other without interrupting the activation of the anode catalyst layer 42.

The inner edge of the anode adhesive layer 83, in one embodiment, is spaced apart by a first interval G21 from a boundary line between the anode edge protection layer 44 and the anode catalyst layer 42. The first interval G21 contributes to preventing or substantially preventing the activation of the anode catalyst layer 42 adjacent to the anode adhesive layer 83 from being interrupted by the anode adhesive layer 83.

The anode edge protection layer 44 prevents or substantially prevents the anode gas diffusion layer 41 from trespassing between the anode catalyst layer 42 and the electrolyte membrane 21, thus preventing or substantially preventing deterioration of the electrolyte membrane 21 caused by contact between the anode gas diffusion layer 41 and the electrolyte membrane 21. Accordingly, a pin hole of the electrolyte membrane 21 caused by the deterioration may be avoided.

In one embodiment, the cathode adhesive layer 93 is provided on the cathode edge protection layer 54 and the cathode gas diffusion layer 51 facing each other to be bonded together, thus attaching the cathode gas diffusion layer 51 to the cathode edge protection layer 54 and the electrolyte membrane 21.

Since the cathode adhesive layer 93 is provided at the outer edge of the cathode catalyst layer 52, the cathode adhesive layer 93 can bond the cathode edge protection layer 54 and the cathode gas diffusion layer 51 to each other without interrupting the activation of the cathode catalyst layer 52.

The inner edge of the cathode adhesive layer 93, in one embodiment, is spaced apart by a second interval G22 from a boundary line between the cathode edge protection layer 54 and the cathode catalyst layer 52. The second interval G22 contributes to preventing or substantially preventing the activation of the cathode catalyst layer 52 adjacent to the cathode adhesive layer 93 from being interrupted by the cathode adhesive layer 93.

The cathode edge protection layer 54 prevents or substantially prevents the cathode gas diffusion layer 51 from trespassing between the cathode catalyst layer 52 and the electrolyte membrane 21, thus preventing or substantially preventing deterioration of the electrolyte membrane 21 caused by contact between the cathode gas diffusion layer 51 and the electrolyte membrane 21. Accordingly, a pin hole of the electrolyte membrane 21 caused by the deterioration may be avoided.

FIG. 8 is a plan view showing the anode edge protection layer 44, the anode catalyst layer 42, and the anode adhesive layer 83 on the electrolyte membrane 21. Referring to FIG. 8, in one embodiment, the anode adhesive layer 83 forms a closed curved line along the anode edge protection layer 44 and thus provides a stable structure for bonding the anode gas diffusion layer 41 and the anode edge protection layer 44.

In one embodiment, the cathode adhesive layer 93 is formed as a closed curved line (not shown) along the cathode edge protection layer 54 and thus provides a stable structure for bonding the cathode gas diffusion layer 51 and the cathode edge protection layer 54.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A membrane electrode assembly comprising:
an electrolyte membrane;
a catalyst layer on the electrolyte membrane;
a gas diffusion layer attached to the catalyst layer; and
an adhesive layer between the electrolyte membrane and the gas diffusion layer around an outer edge of the catalyst layer.

2. The membrane electrode assembly of claim 1, wherein the adhesive layer is on at least one of the electrolyte membrane or the gas diffusion layer facing each other, and bonds the electrolyte membrane and the gas diffusion layer to each other.

3. The membrane electrode assembly of claim 1, wherein an inner edge of the adhesive layer is spaced apart from the outer edge of the catalyst layer.

4. The membrane electrode assembly of claim 1, wherein the adhesive layer is arranged as a closed curved line around the outer edge of the catalyst layer.

5. The membrane electrode assembly of claim 1, further comprising an edge protection layer on an outer portion of the electrolyte membrane along the outer edge of the catalyst layer.

6. The membrane electrode assembly of claim 5, wherein the adhesive layer is on at least one of the edge protection layer or the gas diffusion layer facing each other, and bonds the edge protection layer and the gas diffusion layer to each other.

7. The membrane electrode assembly of claim 6, wherein an inner edge of the adhesive layer is spaced apart from a boundary line between the edge protection layer and the catalyst layer.

8. The membrane electrode assembly of claim 5, wherein the adhesive layer is arranged as a closed curved line along the edge protection layer.

9. The membrane electrode assembly of claim 1, wherein the adhesive layer is heat-treated in a vacuum or atmosphere.

10. The membrane electrode assembly of claim 1, wherein the adhesive layer is heat-treated with ultraviolet rays, electron beams, or visible rays.

11. The membrane electrode assembly of claim 1, wherein the adhesive layer comprises at least one of epoxy, urethane, silicon, or acryl.

12. A fuel cell stack comprising:
a plurality of unit cells, each comprising a membrane electrode assembly and separators attached to both sides of the membrane electrode assembly, respectively; and
a pressure plate supporting and applying pressure to the plurality of unit cells,
wherein the membrane electrode assembly comprises:
an electrolyte membrane;
a catalyst layer on the electrolyte membrane;
a gas diffusion layer attached to the catalyst layer; and
an adhesive layer between the electrolyte membrane and the gas diffusion layer around an outer edge of the catalyst layer.

13. The fuel cell stack of claim 12, wherein the adhesive layer is on at least one of the electrolyte membrane or the gas diffusion layer, and bonds the electrolyte membrane and the gas diffusion layer to each other.

14. The fuel cell stack of claim 12, further comprising an edge protection layer on an outer portion of the electrolyte membrane along the outer edge of the catalyst layer.

15. The fuel cell stack of claim 14, wherein the adhesive layer is on at least one of the edge protection layer or the gas diffusion layer facing each other, and bonds the edge protection layer and the gas diffusion layer to each other.
